(19) United States
(12) Patent Application Publication
(10) Pub. No.: US 2005/0003849 A1
(43) Pub. Date: Jan. 6, 2005

(54) Mobile telephonic apparatus

(76) Inventor: Artoun Ramian, Marbella (ES)

Correspondence Address: Law Office of William B. Ritchie, 43 Jackson Street, Concord, NH, 03301, US

(21) Appl. No.: 10/776,928

(22) Filed: Feb. 11, 2004

Related U.S. Application Data
(60) Provisional application No. 60/446,883, filed on Feb. 12, 2003.

(51) Int. Cl. H04M 1/00

(52) U.S. Cl. 455/550.1

(57) ABSTRACT

A radio antenna used to support a microphone for use in a device such as a mobile telephone such that the combining of the two elements save space and reduces the size and weight when compared to standard techniques. A standard speaker serves as earpiece which is attached to the head of the user or held adjacent to the ear of the user using techniques well known in the art. The microphone is physically attached to the antenna by a plastic bracket or by a Jubilee Clip or other similar device such that the microphone is electrically insulated from the antenna. The microphone will move up and down the length of the antenna in order to match a comfortable working position for a user. In this case, the Jubilee clip can be slackened and the microphone can be raised or lowered along the length of the antenna. In an alternative embodiment, an acoustic tube is used to carry sound from the mouth to a microphone positioned within a module which is held in close proximity to the ear of the user. The antenna is sealed within the acoustic tube.

### BACKGROUND OF INVENTION

This application claims benefit of priority under 35 U.S.C. §119(e) to U.S. Provisional Application Ser. No. 60/446,883, filed on Feb. 12, 2003.

1. Field of the Invention

The present invention generally relates to the construction of radio transmitters and receivers, including mobile telephony.

2. Description of the Related Art

The current art contains many demonstrations of types of radio transceivers (transmitters/receivers), which have a speaker and a microphone. Many transceivers have been constructed which are half-duplex, in that, when one party talks the other must listen. In other words, whilst one transmitter is in transmit mode, at least one other transceiver should be in receive mode. More recently, full duplex communication has been taught, as is demonstrated in telephony, particularly in mobile telephones, enabling both parties to talk and listen substantially simultaneously. This has revolutionized computer communication, as a channel of communication can carry information in two directions at the same time, whereas in prior art devices, i.e., half-duplex units were only able to carry information in one direction at a time.

In half-duplex transceivers, a single speaker can be utilized as an audio output device while receiving, and an audio input device while transmitting. In fact, the speaker acts as a crude microphone while transmitting.

The invention relates to those transceivers having a separate speaker and microphone, particularly those which are constructed to include headsets for the audio input and output features.

The prior art, particularly in the field of mobile telephony, teaches that a transceiver, being a mobile cellular telephone, has a substantially sealed module encompassing among other things a microphone and a speaker. All transceivers are further required to have an antenna for the transmission and reception of radio waves. In cellular telephones, the sealed module provides a speaker, microphone and antenna, wherein the sealed module is held in the hand, in close proximity to the ear, with the microphone being a little distance from the mouth. In order to facilitate a hands-free communication, the prior art features an external headset. This headset either utilizes a rigid structure where an earpiece contains a speaker and a boom used to support a microphone, or a flexible wire that is connected to a speaker and then is connected a microphone. The microphone is left to simply hang in close proximity to the user.

As transceivers have decreased considerably in size over recent years, the prior art has demonstrated that complex FM transmitters can be constructed in extremely small packages, particularly for covert monitoring, i.e., “bugging”. This teaches that small efficient transceivers are possible. Furthermore, the sizes of mobile cellular telephones are following a similar pattern. However, a major impediment to further reduction in size is the distance from the user's ear restriction remains on the reduction of size in that field, and this is the distance from a person's ear to their mouth.

Another size reduction problem is the length of a radio wave for which an antenna has to be constructed. One means of addressing this problem has been to construct half-wave and quarter-wave antennas, and these have been found to work efficiently.

Therefore, it can be seen that size reduction will go so far, but certain real world physical dimensions will remain constant. Consequently, it is surprising that those elements which are cannot be downsized further independent of one another have not been combined in order to achieve further reductions in size and weight savings. That is, no prior art uses the antenna as a supporting structure for other elements of a transceiver or even recognizes this possibility. In the prior art, the only function of an antenna is to transmit or receive radio waves.

Typically, when objects come into close proximity of an antenna, the performance of the antenna is adversely affected. However, in the field of cellular telephones, it seems that virtually regardless of alien object proximity, the antenna seems to function adequately at all times, as can be seen by users that use cellular telephones in cars, where the cellular telephone is obviously close to the metal chassis of the vehicle. However, the use of an antenna to support other components of the cellular telephone has not been disclosed or suggested in the prior art.

### SUMMARY OF THE PRESENT INVENTION

It is an aspect of the present invention to further reduce the size and number of components used in constructing radio transceivers. An acoustic tube is provided which serves to carry sound to a microphone and to route an antenna to a transceiver. The antenna, in addition to its antenna functions, serves to support a microphone.

An antenna also can support other components used to construct a full duplex radio transceiver. Objects in close proximity to an antenna will cause the antenna to operate less effectively, although this reduced efficiency is still sufficient for cellular telephones to operate well within accepted standards.

In the preferred embodiment, the antenna is used to physically support a microphone. In alternative embodiment, an acoustic tube is used to carry sound from the mouth to a microphone positioned within a module which is held in close proximity to the ear of the user. The antenna is sealed within the acoustic tube.

An acoustic tube is a short length of pipe material, where one end of the pipe is positioned close to the mouth of the user, and the opposite end is placed around a microphone, such that, sound waves emanating from the mouth are guided to the microphone which may be several inches from the mouth of the user. This type of arrangement is found in some products manufactured by Plantronics.

Other aspects, features and advantages of the present invention will become obvious from the following detailed description that is given for one embodiment of the invention while referring to the accompanying drawings.

### BRIEF DESCRIPTION OF THE DRAWINGS

FIG. 1 illustrates the preferred embodiment of the transceiver microphone apparatus in accordance with the invention.

FIG. 2 illustrates an alternate embodiment of the invention.

### DETAILED DESCRIPTION OF THE INVENTION

The invention, in the preferred embodiment, is a radio antenna used to support a microphone. An alternate embodiment demonstrates a method of using a pipe-like microphone tube which contains an embedded antenna, with both the preferred and the alternative embodiment showing how space saving, size reducing and weight reducing benefits are providing by the invention.

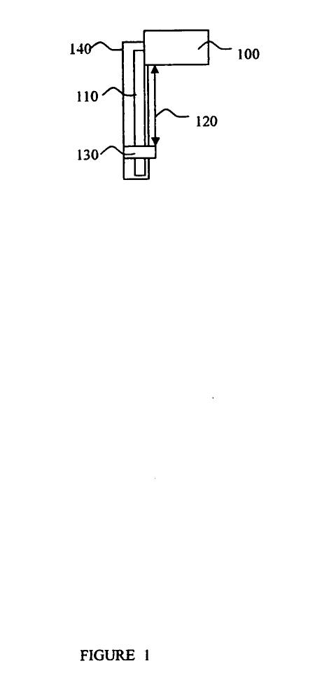

Referring to FIG. 1, a diagram of the preferred embodiment is illustrated. Speaker 100 is a standard earpiece which attaches to the head of the user being retained by a band (not shown) which spans the head of the user. Alternatively, a simple clip (not shown), well known in the art, can be used to maintain the position of speaker 100 against the ear of the user.

Antenna 110 is mounted on the enclosure which seals speaker 100, in other words, the casing of speaker 100, which keeps speaker 100 dust free and insulated. A bracket (not shown) holds antenna 110. Speaker 100 is the only major component within the casing of speaker 100. Speaker 100 is required to be attached to a radio transceiver or other two way communication device in order to offer sound input and output capabilities corresponding with the radio transceiver.

Antenna 110 is required to be also connected to a radio transceiver, or radio receiver, or radio transmitter in order that waves it encounters are passed to a corresponding radio frequency receiver or waves emanating from a corresponding radio frequency transmitter can be transmitted from antenna 110. Antenna 110, in the prior art, is normally connected to any radio frequency device by means of coaxial cable, which is well known in the art.

Wire 120, is a screened audio cable, which carries audio information, arriving at microphone 130, to the corresponding radio frequency device.

Microphone 130 is physically attached to antenna 110 by a plastic bracket or by a Jubilee Clip or other similar device provided that microphone 130 is electrically insulated from antenna 110.

Microphone 130 will be required to move up and down the length of antenna 110 in order to match a comfortable working position for the user. In this case, the Jubilee clip can be slackened and microphone 130 can be raised or lowered along the length of antenna 110. At no time can antenna 110 be physically shortened or lengthened as this would effectively disrupt the Standing Wave Ratio (SWR) value, i.e., the efficiency of antenna 110.

It is important to note that microphone 130 is also shielded as is wire 120, in order to ground any radio frequency interference induced in microphone 130 or wire 120 emanating from antenna 110.

The polarity of antenna 110 is substantially fixed within a narrow range of rotation. Cellular telephones are known to work in virtually any orientation, or polarity. Therefore, any position, which is comfortable for the user, will not adversely affect the efficiency of the corresponding radio frequency device.

If antenna 110 does not provide sufficient length, due to the wavelength in use by the radio frequency device, then sheath 140 can be used to extend the length of antenna 110. Sheath 140 is a rigid cylindrical form into which antenna 110 is embedded and upon which microphone 130 is mounted rather than being mounted directly on antenna 110.

The length of sheath 140 is variable as it must not be electrically conductive. Sheath 140 will further increase electrical insulation between antenna 110 and microphone 130.

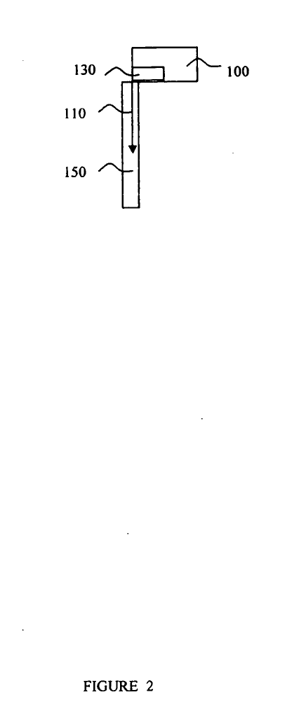

As shown in FIG. 2, an alternative embodiment of the invention is illustrated. Microphone 130 is now placed in the same enclosure as speaker 100. Sound waves now enter pipe 150, a substantially rigid plastic tube, which has one end presented close to the mouth of the user, with the remaining end positioned around microphone 130, which is placed substantially inside of pipe 150, such that sound waves travel along pipe 150 and are guided over microphone 130.

Antenna 110 can now be a single core wire traveling along the wall of pipe 150 and can be set to a length appropriate for said radio frequency device.

The illustrated embodiments of the invention are intended to be illustrative only, recognizing that persons having ordinary skill in the art may construct different forms of the invention that fully fall within the scope of the subject matter disclosed.

1. A mobile telephonic apparatus for a user, said apparatus comprising:
a housing;
a speaker positioned with said housing, wherein said speaker is adapted to provide input and output signals;
an antenna rotatably attached to said housing and is adapted to receive radio waves;
a microphone adapted to transmit audio signals and is supported by said antenna such that said microphone is able to be slid along said antenna by the user until the position of said microphone is in a comfortable position for the user.

2. A mobile telephonic apparatus for a user, said apparatus comprising:
a housing;
a speaker positioned with said housing, wherein said speaker is adapted to provide input and output signals;
a microphone also positioned with said housing and is adapted to transmit audio signals;
an acoustic pipe having a mouth end, a microphone end, and an inside wall wherein the mouth of said acoustic pipe is presented close to the mouth of the user and wherein the microphone end of said acoustic pipe is immediately adjacent to said microphone such that sound waves from the user's voice are transmitted along said acoustic pipe to said microphone;
an antenna adapted to receive radio waves and comprises a single core wire positioned along the inside wall of said acoustic pipe.

3. A mobile telephonic apparatus for a user, said apparatus comprising:
a housing;
a speaker positioned with said housing, wherein said speaker is adapted to provide input and output signals;
an electrically nonconductive variable length sheath rotatably attached to said housing;
an antenna embedded with said sheath and is adapted to receive radio waves;
a microphone adapted to transmit audio signals and is supported by said sheath such that said microphone is able to be slid along said sheath by the user until the position of said microphone is in a comfortable position for the user.
